(19) United States
(12) Patent Application Publication
(10) Pub. No.: US 2015/0170445 A1
(43) Pub. Date: Jun. 18, 2015

(54) MANAGING VEHICLE PARKING

(71) Applicant: Sadanand R. Bajekal, Austin, TX (US)

(72) Inventor: Sadanand R. Bajekal, Austin, TX (US)

(21) Appl. No.: 14/506,680

(22) Filed: Oct. 5, 2014

Related U.S. Application Data
(63) Continuation of application No. 14/109,694, filed on Dec. 17, 2013.

(51) Int. Cl. G07C 9/00

(52) U.S. Cl. CPC G07C 9/00111

(57) ABSTRACT

A method for administering a set of vehicle parking facilities shared by a plurality of tenants, including managing an administrative domain accessible by a parking administrator, the administrative domain capable of communicating with a plurality of tenant domains; and managing an access enforcement system in communication with tag sensors and gates at access points of the vehicle parking facilities for reading tags to obtain a current tag identifier of a current vehicle at a current gate, and providing a signal to the current gate allowing the current vehicle to proceed through the access point; wherein user attributes in the tenant domains are secured from access by the parking administrator.

This application is a continuation of application Ser. No. 14/109,694 filed Dec. 17, 2013 entitled “MANAGING VEHICLE PARKING”, the disclosure of which is incorporated in its entirety herein by reference.

### BACKGROUND

1. Technical Field

The present invention relates generally to managing vehicle parking, and in particular, to a computer implemented method for administering shared parking facilities for multiple tenants.

2. Description of Related Art

A variety of techniques have been utilized in the past by entities for managing parking across parking facilities. A common technique is the use of a parking sticker assigned to individuals that is affixed to a windshield or bumper. The sticker is obtained by the individual vehicle owner through a registration process with the entity, such as a school or business. The registration is specific to the vehicle given the affixed nature of the sticker. Alternatively, a tag may be obtained by an individual that is hung from the rear view mirror or displayed in the interior dash of the vehicle. The registration of the tag is typically specific to the individual, although visitor tags may be provided on occasion. Each tag may be utilized in multiple vehicles owned by the registering individual, although each vehicle may be registered as a potential user of the tag.

Parking is then typically enforced through the use of attendants walking or driving through parking lots looking for vehicles without approved stickers or tags. Unauthorized vehicles may be ticketed, towed, or booted to prevent vehicle movement until the vehicle owner contacts the entity.

### SUMMARY

The illustrative embodiments provide a method for administering a set of vehicle parking facilities shared by a plurality of tenants, including managing an administrative domain accessible by a parking administrator, the administrative domain capable of communicating with a plurality of tenant domains; and managing an access enforcement system in communication with tag sensors and gates at access points of the vehicle parking facilities for reading tags to obtain a current tag identifier of a current vehicle at a current gate, and providing a signal to the current gate allowing the current vehicle to proceed through the access point; wherein user attributes in the tenant domains are secured from access by the parking administrator.

### BRIEF DESCRIPTION OF THE SEVERAL VIEWS OF THE DRAWINGS

The novel features believed characteristic of the invention are set forth in the appended claims. The invention itself, further objectives and advantages thereof, as well as a preferred mode of use, will best be understood by reference to the following detailed description of illustrative embodiments when read in conjunction with the accompanying drawings, wherein:

FIG. 1 is a block diagram of an illustrative data processing system in which various embodiments of the present disclosure may be implemented;

FIG. 2 is a block diagram of an illustrative network of data processing systems in which various embodiments of the present disclosure may be implemented;

FIG. 3 is a block diagram of a parking administration system in which various embodiments may be implemented;

FIG. 4A-4D are block diagrams of types of database records in accordance with a first and a second embodiments;

FIGS. 5A-5C are flow diagrams of managing parking in accordance with the first embodiment;

FIGS. 6A-6C are flow diagrams of managing parking in accordance with the second embodiment;

FIGS. 7A through 7D are block diagrams of types of database records in accordance with a third embodiment;

FIGS. 8A through 8C are flow diagrams of managing parking in accordance with the third embodiment; and

FIG. 9 is a flow diagram of managing an automated accounting system in which various embodiments may be implemented.

### DETAILED DESCRIPTION

Processes and devices may be implemented and utilized for managing vehicle parking. These processes and apparatuses may be implemented and utilized as will be explained with reference to the various embodiments below.

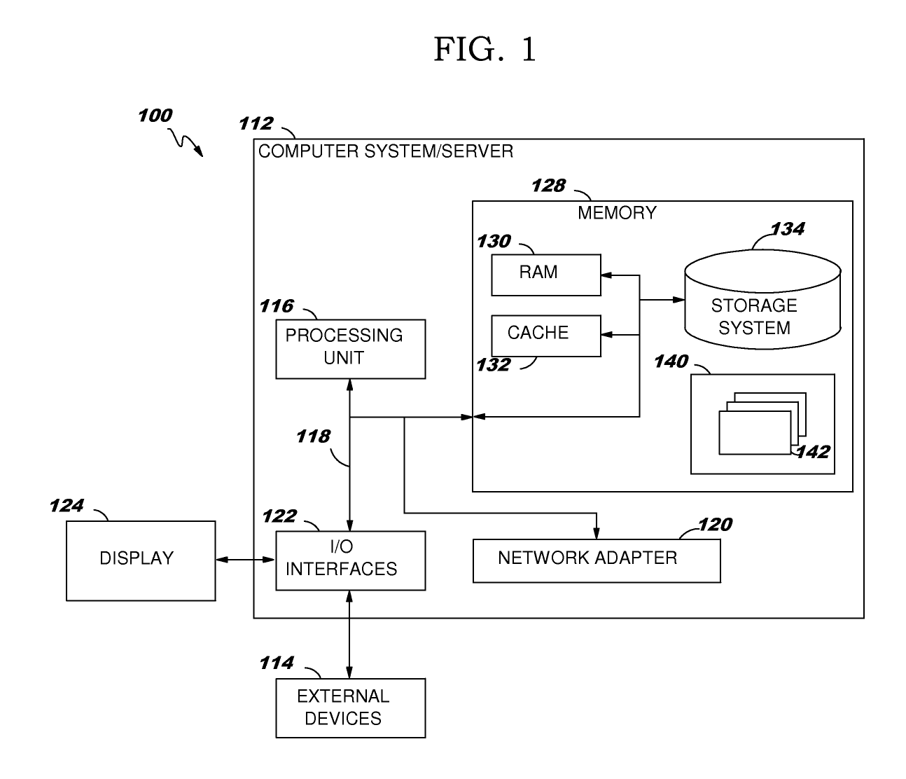

FIG. 1 is a block diagram of an illustrative data processing system in which various embodiments of the present disclosure may be implemented. Data processing system 100 is one example of a suitable data processing system and is not intended to suggest any limitation as to the scope of use or functionality of the embodiments described herein. Regardless, data processing system 100 is capable of being implemented and/or performing any of the functionality set forth herein such as managing vehicle parking.

In data processing system 100 there is a computer system/server 112, which is operational with numerous other general purpose or special purpose computing system environments, peripherals, or configurations. Examples of well-known computing systems, environments, and/or configurations that may be suitable for use with computer system/server 112 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 112 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 112 may be practiced in distributed computing environments where tasks are performed by remote processing devices that are linked through a communications network. In a distributed computing environment, program modules may be located in both local and remote computer system storage media including memory storage devices.

As shown in FIG. 1, computer system/server 112 in data processing system 100 is shown in the form of a general-purpose computing device. The components of computer system/server 112 may include, but are not limited to, one or more processors or processing units 116, a system memory 128, and a bus 118 that couples various system components including system memory 128 to processor 116.

Bus 118 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 112 typically includes a variety of non-transitory computer system readable media. Such media may be any available media that is accessible by computer system/server 112, and it includes both volatile and non-volatile media, removable and non-removable media.

System memory 128 can include non-transitory computer system readable media in the form of volatile memory, such as random access memory (RAM) 130 and/or cache memory 132. Computer system/server 112 may further include other non-transitory removable/non-removable, volatile/non-volatile computer system storage media. By way of example, storage system 134 can be provided for reading from and writing to a non-removable, non-volatile magnetic media (not shown and typically called a “hard drive”). Although not shown, a USB interface for reading from and writing to a removable, non-volatile magnetic chip (e.g., a “flash drive”), and an optical disk drive for reading from or writing to a removable, non-volatile optical disk such as a CD-ROM, DVD-ROM or other optical media can be provided. In such instances, each can be connected to bus 118 by one or more data media interfaces. Memory 128 may include at least one program product having a set (e.g., at least one) of program modules that are configured to carry out the functions of the embodiments. Memory 128 may also include data that will be processed by a program product.

Program/utility 140, having a set (at least one) of program modules 142, may be stored in memory 128 by way of example, and not limitation, as well as an operating system, one or more application programs, other program modules, and program data. Each of the operating system, one or more application programs, other program modules, and program data or some combination thereof, may include an implementation of a networking environment. Program modules 142 generally carry out the functions and/or methodologies of the embodiments. For example, a program module may be software for managing vehicle parking.

Computer system/server 112 may also communicate with one or more external devices 114 such as a keyboard, a pointing device, a display 124, etc.; one or more devices that enable a user to interact with computer system/server 112; and/or any devices (e.g., network card, modem, etc.) that enable computer system/server 112 to communicate with one or more other computing devices. Such communication can occur via I/O interfaces 122 through wired connections or wireless connections. Still yet, computer system/server 112 can communicate with one or more networks such as a local area network (LAN), a general wide area network (WAN), and/or a public network (e.g., the Internet) via network adapter 120. As depicted, network adapter 120 communicates with the other components of computer system/server 112 via bus 118. It should be understood that although not shown, other hardware and/or software components could be used in conjunction with computer system/server 112. Examples, include, but are not limited to: microcode, device drivers, tape drives, RAID systems, redundant processing units, data archival storage systems, external disk drive arrays, etc.

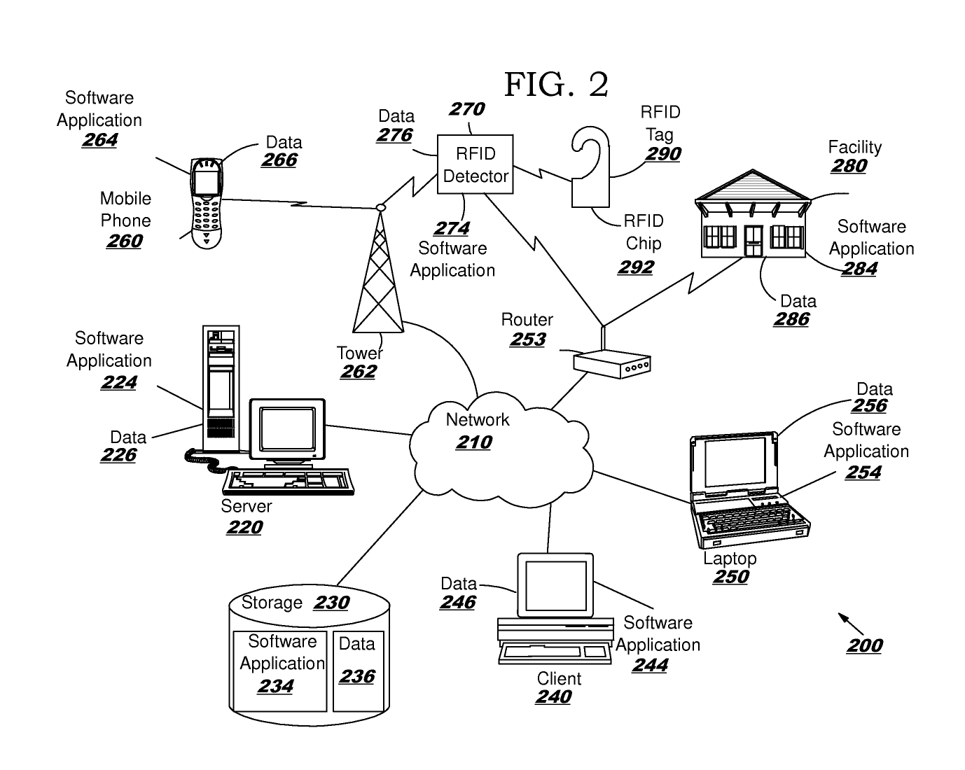

FIG. 2 is a block diagram of an illustrative network of data processing systems in which various embodiments of the present disclosure may be implemented. Data processing environment 200 is a network of data processing systems such as described above with reference to FIG. 1. Software applications such as for managing vehicle parking may execute on any computer or other type of data processing system in data processing environment 200. Data processing environment 200 includes network 210. Network 210 is the medium used to provide simplex, half duplex and/or full duplex communications links between various devices and computers connected together within data processing environment 200. Network 210 may include connections such as wire, wireless communication links, or fiber optic cables.

Server 220 and client 240 are coupled to network 210 along with storage unit 230. In addition, laptop 250, RFID detector 270 and facility 280 (such as a home or business) are coupled to network 210 including wirelessly such as through a network router 253. A mobile phone 260 and RFID detector 270 may be coupled to network 210 through a mobile phone tower 262. Data processing systems, such as server 220, client 240, laptop 250, mobile phone 260, RFID detector 270, and facility 280 contain data and have software applications including software tools executing thereon. Other types of data processing systems such as personal digital assistants (PDAs), smartphones, tablets and netbooks may be coupled to network 210. An RFID tag 290 may contain an RFID chip 292 which can be detected by RFID detector 270.

Server 220 may include software application 224 and data 226 for managing vehicle parking or other software applications and data in accordance with embodiments described herein. Storage 230 may contain software application 234 and a content source such as data 236 for managing vehicle parking. Other software and content may be stored on storage 230 for sharing among various computer or other data processing devices. Client 240 may include software application 244 and data 246. Laptop 250 and mobile phone 260 may also include software applications 254 and 264 and data 256 and 266. RFID detector 270 may include software applications 274 and data 276. Facility 280 may include software applications 284 and data 286. Other types of data processing systems coupled to network 210 may also include software applications. Software applications could include a web browser, email, or other software application for managing vehicle parking.

Server 220, storage unit 230, client 240, laptop 250, mobile phone 260, RFID detector 270 and facility 280 and other data processing devices may couple to network 210 using wired connections, wireless communication protocols, or other suitable data connectivity. Client 240 may be, for example, a personal computer or a network computer.

In the depicted example, server 220 may provide data, such as boot files, operating system images, and applications to client 240 and laptop 250. Server 220 may be a single computer system or a set of multiple computer systems working together to provide services in a client server environment. Client 240 and laptop 250 may be clients to server 220 in this example. Client 240, laptop 250, mobile phone 260, RFID detector 270 and facility 280 or some combination thereof, may include their own data, boot files, operating system images, and applications. Data processing environment 200 may include additional servers, clients, and other devices that are not shown.

In the depicted example, data processing environment 200 may be the Internet. Network 210 may represent a collection of networks and gateways that use the Transmission Control Protocol/Internet Protocol (TCP/IP) and other protocols to communicate with one another. At the heart of the Internet is a backbone of data communication links between major nodes or host computers, including thousands of commercial, governmental, educational, and other computer systems that route data and messages. Of course, data processing environment 200 also may be implemented as a number of different types of networks, such as for example, an intranet, a local area network (LAN), or a wide area network (WAN). FIG. 2 is intended as an example, and not as an architectural limitation for the different illustrative embodiments.

Among other uses, data processing environment 200 may be used for implementing a client server environment in which the embodiments may be implemented. A client server environment enables software applications and data to be distributed across a network such that an application functions by using the interactivity between a client data processing system and a server data processing system. Data processing environment 200 may also employ a service oriented architecture where interoperable software components distributed across a network may be packaged together as coherent business applications.

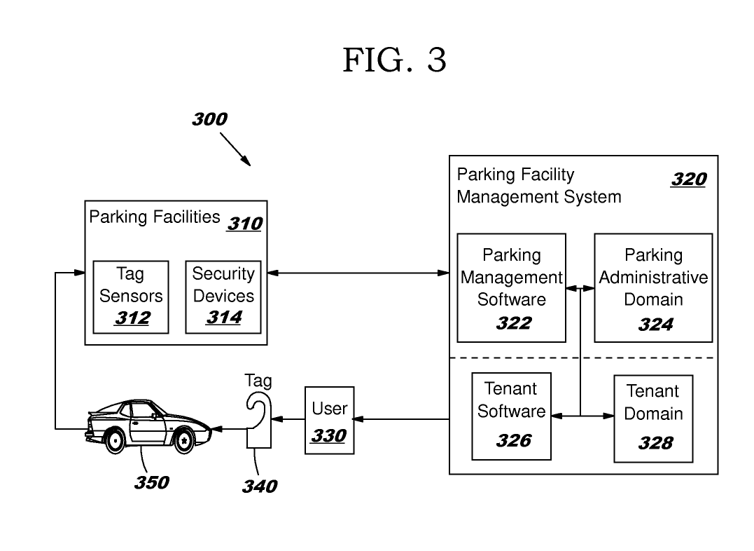

FIG. 3 is a block diagram of a parking administration system 300 in which various embodiments may be implemented. A set of parking facilities 310 may be a surface parking lot, a parking garage, other types of parking facilities, or a plurality and/or combination of the foregoing. Parking facilities 310 include tag sensors 312 such as RFID sensors for determining the identity of a tag entering or exiting through a gate at the parking facilities. The tag sensors can include RFID sensors for detecting RFID chips embedded in tags with vehicles located near or at the parking facilities. Alternatively, the tags may be stickers affixed to vehicle with visual identifying markings that can be read by a video camera in combination with optical recognition software, or other forms of tag identification. Parking facilities 310 may also include security devices 314 for preventing vehicles from entering or exiting the parking facilities or portions thereof such as parking road barrier gates, sliding or swinging gates, security bollards, or other types of gates.

A parking facility management system 320 (also referred to herein as parking management system) interfaces with tag sensors 312 and security devices 314 to manage access to parking facilities 310. Parking facility management system includes parking management software 322 and a parking administrative domain 324 (also referred to herein as an administrative database or domain). Parking management software 322 interfaces with tag sensors 312 and security devices 314 and utilizes data stored in parking administrative domain 324 to manage access to parking facilities 310 as an access enforcement system. Parking management software may also interface with tenant domain 328 such as to identify the tenant associated with a given tag and to confirm whether a certain tag includes special needs parking privileges. Parking management software can also manage accounting for tenant parking including providing for automated payment system for parking by the tenant for the users, providing flexible parking plans which can be managed by the tenants, etc. A description of the operation of parking management software is provided below.

Parking facility management system 320 also includes tenant software 326 and tenant domain 328. Although a single tenant is shown, multiple tenant domains and software may be utilized for multiple tenants, each tenant having multiple users. Tenant software 326 and domain 328 may be located on the same server or on different servers as different locations as parking management software 322 and parking administrative domain 324. For example, parking administrative domain 324 and tenant domain 328 may be included in the same database as separate domains where a parking administrator has exclusive access to the parking administrative domain and the tenant has exclusive access to the tenant domain, or they may be separate databases on separate servers and even separate locations. This allows for each entity to maintain and secure privacy and administrative control for their information including accounting information and parking user information. Parking administrative domain 324 and tenant domain 328 may be referred to herein as databases even if they are the same database with different domains within that database or if they are separate databases. Tenant domain 328 includes attribute information about each user of each tag such as name, employee status, shift, whether authorized to park in special needs parking, etc. The user attribute information is secured from access by anyone other than the tenant managing that tenant domain, thereby preventing access to that information by the parking administrator or other tenants. Selected information such as whether a specific tag has been assigned to a user and whether the user is authorized to park in special needs parking may be uploaded to the parking administrative database for ease of managing special needs parking.

A tag such as an RFID tag 340 can be assigned to a particular user 330 by the tenant. The assignment may be by the tenant or directly by the user such as through a kiosk. Although a single user is shown, each tenant may have one or multiple users, each user being assigned a specific tag with a unique tag id. In some cases, a single user may have multiple tags. That assignment is registered in the tenant database and selected information from the tenant database may be automatically updated to the parking administrative database. The upload may occur upon registration, periodically, or when the tag is first used by the user in the parking facilities. The upload may not include personal information about the user to protect the user's privacy. However, selected information such as whether the user is authorized to park in reserved locations may be uploaded. Each tag may contain an RFID chip which transmits the tag ID such as within a tag that hangs from the rear view mirror or within a sticky patch that is affixed to the interior of the windshield. Alternatively, other types of devices may be included in the tag for providing the tag ID such as a battery operated Wi-Fi or LED devices which emit a code (referred to herein is a code emitting device in a code emitting tag) or a visual code that can be scanned with the use of a video camera or other photo capture device. Optionally, each tag may also have a unique tag number that is human readable for ease of distinguishing between tags.

The user then places or affixes the tag to the desired vehicle 350 which is then driven to parking facility 310. Upon approaching or entry to the parking facility, the tag ID is obtained from the tag. The parking management software then determines the tenant number and any parking attributes (e.g., eligible for certain parking spaces) for that tag from the parking administrative database. The parking facility can then be instructed to allow or disallow the vehicle from parking in the parking facility. The vehicle tag ID can also be obtained when the vehicle leaves the facility, thereby providing an accounting of the time spent in the parking facilities. Examples of these processes are described below.

Due to the flexibility of this system, a variety of types of agreements may be made between the parking administrator and each tenant including providing parking on a fixed fee for a certain number of parking spaces, a use fee for parking depending on the number and time of parking spaces used, etc. The tenant can be invoiced for the vehicle parking at the parking facility according to the agreement between the parking administrator and the tenant.

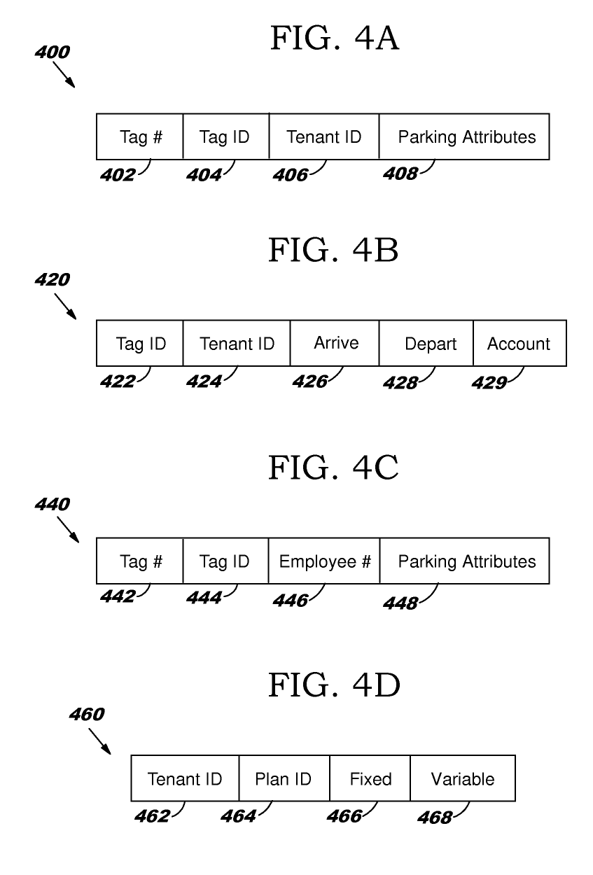

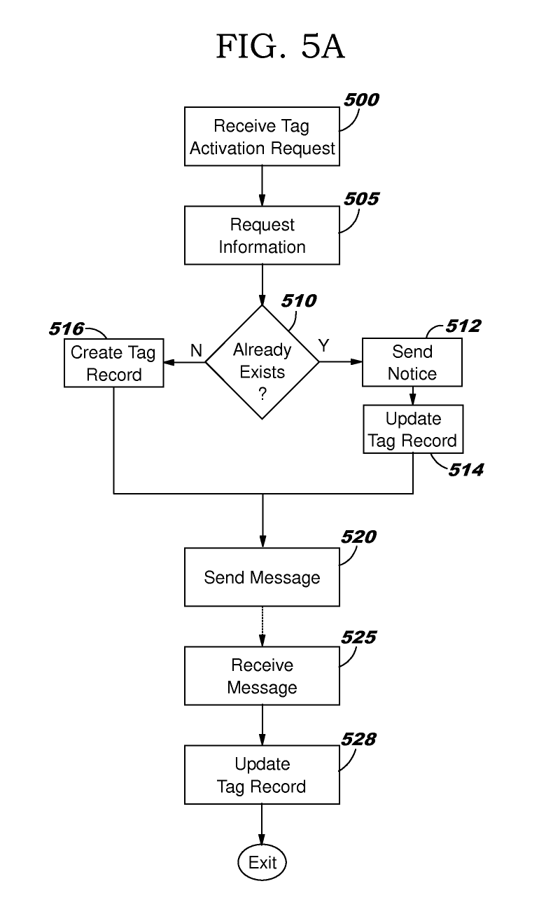

FIGS. 4A through 4D are block diagrams of types of database records in accordance with a first and a second embodiment. A record is a set of information within a domain or database that establishes a relationship between a set of data or data elements. A record may be a separate entry into a database, a set of links between data, or other logical relationship between a set of data. FIG. 4A is a block diagram 400 of a record stored in a registration database for an assigned tag, which may be included in the parking administrative database. FIG. 4B is a block diagram 420 of a record stored in a usage database which can also be included in the parking administrative database. FIG. 4C is a block diagram 440 of a record stored in a tenant registration database for an assigned tag, which may be included in the tenant database. FIG. 4D is a block diagram 460 of a record stored in the parking administrative database and may also be mirrored in the tenant database for managing parking accounting. In each of these database records for the first and second embodiments, no identifying information regarding the vehicle parking with the tag is captured. This allows the user to move the tag among multiple vehicles which may be owned, leased or otherwise in possession of the user.

FIG. 4A is a block diagram 400 of a record stored in a registration database for an assigned tag, which may be included in the parking administrative database. There may be one record for each tag provided to a tenant for use, although alternative embodiments may include one record per tenant with that record including a list of tags assigned to that tenant. Each record includes a tag number 402, a tag identifier 404, a tenant identifier 406 and any parking attributes 408 for that tag. Tag number (tag #) 402 is a human readable unique number printed on the tag for ease of distinguishing between tags. Tag identifier (tag ID) 404 is a unique machine readable identifier such as a code emitted by an RFID chip which is used to identify a tag with a vehicle. Tenant identifier (tenant ID) 406 is an identifier of a tenant which may assign tags to its employees, guests or other persons. The tenant identifier is also linked to any leasing agreement between the parking administrative entity and the tenant. Parking attributes 408 includes any parking privileges or restrictions associated with a given tag. As each tag is provided to a tenant to provide to its users, a record is created for that tag. Information such as parking attributes may be updated by the tenant as the tags are assigned to users or at other periods as desired. For example, if a user leaves the employment of the tenant, any tag associated with that user by the tenant may be voided and all parking privileges for that user may be revoked by the tenant. That is, the tenant may disassociate the user number or any other user attributes from the tag ID as described below, which is uploaded to the parking administrative database as a “void” parking attribute. The parking management software will then disallow any vehicle with the void parking tag from parking in any parking lot until the tag is recovered from the user and returned to the parking administrator for reuse or reassignment to another tenant, or associated with another user by the tenant.

FIG. 4B is a block diagram 420 of a record stored in a usage database which can be included in the parking administrative database. One record may be automatically created each time a vehicle with a tag parks in the parking facilities (a parking event). This log may be utilized to invoice tenant for usage of the parking facilities. Each record includes the tag identifier 422, tenant identifier 424, arrival time 426, departure time 428, and account information 429. Tag identifier 422 is detected by security devices and used to identify the tag being used at the time of parking. For ease of reference, the tenant identifier 424 associated with the tag may be included in this log record. The time of arrival 426 and time of departure 428 are also included for determining the amount of time the vehicle was parked in the parking facility and the time of day of the parking. For example, the parking administrative entity may charge more or less for parking at certain times of day. Other information may be stored with each record such as where the vehicle was parked (i.e., which parking lot, parking space, etc.), whether the vehicle was improperly parked in an incorrect parking space, etc. This type of information may be useful in assigning parking fines or fees or for revoking parking privileges for a particular tag. Account information 429 maintains accounting information useful for managing charges and invoicing for this parking event. For example, charges may differ by where the user parks or which parking facility the user parks in, so that information may be captured here. In another example, if the tenant already had users parking as many vehicles in the parking facilities as allowed for the tenant, then extra charges may be levied for the additional vehicle, so that information may be captured here. The identity of the user is not included in this record or database, so the privacy of the user and his or her individual actions are maintained.

FIG. 4C is a block diagram 440 of a record stored in a tenant registration database for an assigned tag, which is included in the tenant database. Certain information in this record (e.g., the employee number or any other employee attribute information) is not shared with the parking administrative database for privacy purposes. In this example, there may be one record for each tag obtained for use from the parking administrative entity. Each record includes a tag number 442, a tag identifier 444, an employee number 446 and any parking attributes 448 for that tag. Tag number (tag #) 442 is a human readable unique number printed on the tag for ease of distinguishing between tags. Tag identifier (tag ID) 444 is a unique machine readable identifier such as a code emitted by an RFID chip which is used to identify a tag with a vehicle. In an alternative embodiment, the tag ID may not be included as the tag number may be sufficient for interactions with the parking administrative database. Employee number (employee #) 446 or other employee attribute such as an employee identifier, shift, etc. is utilized to identify a tenant employee or other authorized person and may be used to interface with any employee database of the tenant. Parking attributes 448 includes any parking privileges or restrictions associated with a given tag. Parking attributes may be updated by the tenant as the tags are assigned to users or at other periods as desired. For example, if a user leaves the employment of the tenant, any tag associated with that user may be voided by the tenant and all parking privileges revoked until the tag is associated with another employee. That is, the tenant may disassociate the employee number from the tag number, which is uploaded as a voided tag to the parking administrator (without necessitating uploading the employee number or other identifying information) and the tag may not be utilized for parking. However, once the tag is recovered by the tenant, the tag may be associated with another employee. The fact that the tag is no longer void and useful may then be uploaded as a parking attribute to the parking administrative database so that the tag may be utilized for parking again.

FIG. 4D is a block diagram 460 of an accounting record stored in the parking administrative database and may also be mirrored in the tenant database for managing parking accounting. This record may be accessible by the tenant identified for on-demand or periodic management by the tenant. There may be one record for each tenant, although alternative embodiments may utilize multiple records per tenant such as by parking facility for each tenant. This may be maintained in the parking administrative database with a mirror copy of individual records in tenant databases, although alternative embodiments may utilize alternative configurations.

A tenant ID 462 is an identifier of the tenant for identifying the tenant for which this record applies and for managing which tenant may access this record. Plan ID 464 is an identifier of an accounting plan selected by the tenant. For example, some plans may be static and only allow a certain number of parking spaces for certain parking lots at a given time. Other plans may be dynamic and allow extra parking spaces at a premium cost. Rather than having a detailed description of each plan in each record, an identifier is utilized instead which may be linked to an additional database with the plan details. Fixed 466 and variable 468 are standard limitations on the number of parking spaces allocated to a tenant at any given time. For example, a tenant may pay for 100 parking spaces at a low cost, but then will pay for an additional 20 spaces at any time at a premium cost should the need arise. Many other alternative configurations and types of data may be stored in this and other records.

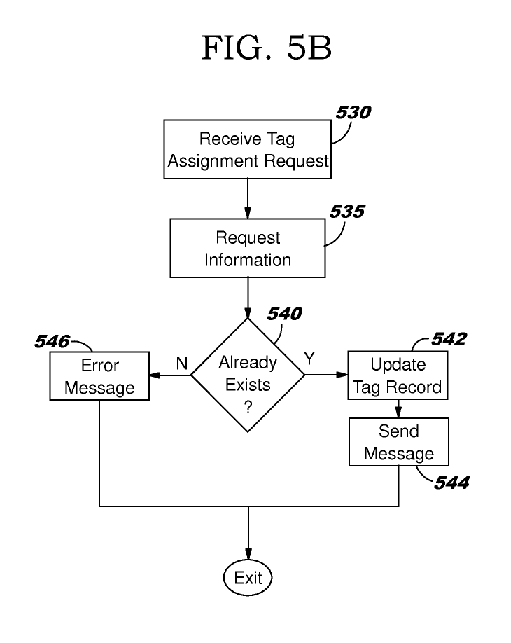

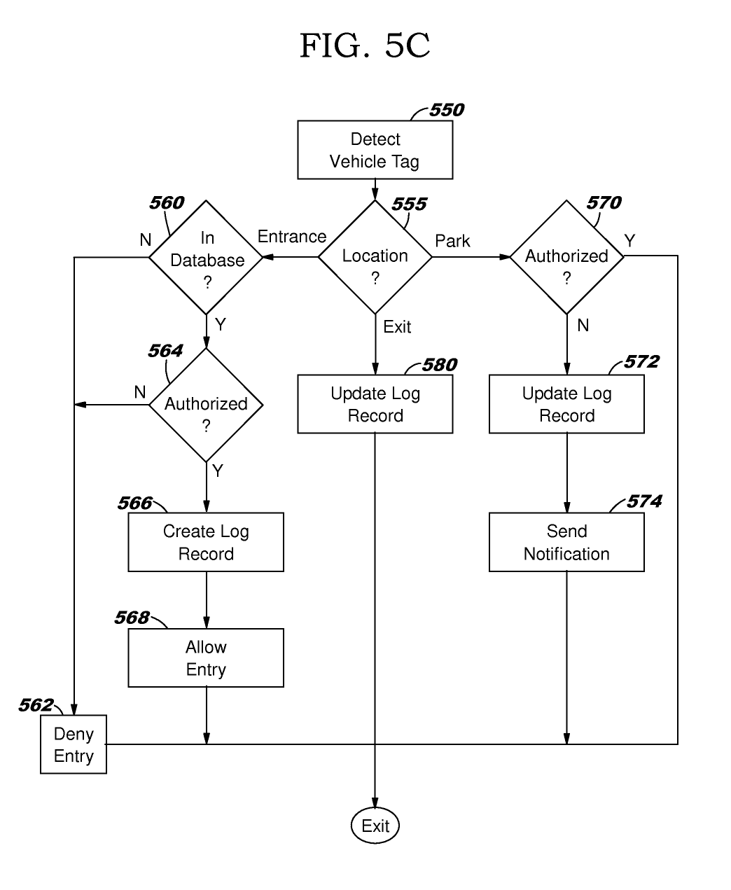

FIGS. 5A through 5C are flow diagrams of managing parking in accordance with the first embodiment. This first embodiment utilizes more upfront data flow from the tenant database to the parking administrative database. FIG. 5A is a flow diagram of the parking management software associating a tag with a tenant in the parking administrative database. FIG. 5B is a flow diagram of the tenant software registering a tag with a user in the tenant database. FIG. 5C is a flow diagram of the parking management software managing a parking facility.

FIG. 5A is a flow diagram of the parking management software associating a tag with a tenant in the parking administrative database in accordance with the first embodiment. In a first step 500 a request is received to activate a tag by associating that a tag with a specific tenant. This request should originate at the parking administrator through a user interface with the parking administrative software. In response, the tag #, tag ID, tenant ID and any expected parking attributes for that tag are requested in step 505. For example, a specific tenant may be restricted to a specific parking lot. In addition, the tag may also include a parking attribute code for disallowing parking with the tag until an update is received from the tenant software indicating the tag was assigned to a user. In step 510, it is determined whether a record for that tag already exists in the parking administrative database. This may occur is a tag is being recycled for use with the same or a different tenant. If yes in step 510, then in step 512 the tenant database for the old record is sent a notice that the tag is being recycled. Then in step 514, the record for that tag in the parking administrative database is updated with the newly provided information and processing continues to step 520. If no in step 510, then in step 516 a new record is created in the parking administrative database with the newly provided tag information and processing continues to step 520.

In step 520, a message is sent to the tenant database corresponding to the tenant #. This message includes the tag # and the tag ID. This allows the tenant database to generate a tag record as described below. Processing then ceases with regards to this tag until a message is received in step 525 indicating that the tag has been activated (assigned to an employee or other authorized person). This message should include any parking attributes such as whether the user can park in certain restricted spaces. Then in step 528, the tag record in the parking administrative database is updated and the parking attributes updated to allow use of the parking tag by a user. Processing then ceases unless a subsequent message is received from the tenant software with updated parking attributes. Such updated attributes could include cancelling the parking tag and thereby revoking the parking privileges associated with that tag.

FIG. 5B is a flow diagram of the tenant software registering a tag with a user in the tenant database in accordance with the first embodiment. In a first step 530, a request is received to assign a tag with a specific user. This request should originate at the tenant through a user interface with the tenant software, database or domain, which may be linked to other tenant databases and software. In response, the tag #, tag ID, employee # or other employee attributes and any expected parking attributes for that tag are requested in step 535. For example, that user may be allowed to park in certain restricted parking spaces such as special needs parking or an employee of the month parking space. In step 540, it is determined whether a record for that tag already exists in the tenant database. This may occur if the tag is a new tag that was recently activated in the parking administrative database or if the tag is being recycled for use with the same or a different user. If yes in step 540, then in step 542 the old record in the tenant database is updated with the newly provided information and processing continues to step 544 where a message is sent to the parking administrative database with the updated parking attributes for processing as described above. Processing then ceases for this tag. If no in step 540, then the tag has not been activated in the parking administrative database, so in step 546 an error message is provided and processing ceases. Alternatively, the tenant software may perform the steps of activating the tag in the parking administrative database.

FIG. 5C is a flow diagram of the parking management software managing a parking facility in accordance with the first embodiment. In this embodiment, due to the parking attributes being stored in the parking administrative database, the tenant software and database does not need to be queried each time a person parks a vehicle with that tag. Queries to the tenant database should be very limited and are not intended to obtain private information of the user. For example, if a car is parked in a restricted area such as a fire lane, then the tenant may be notified prior to the vehicle being towed (for notifying the user), yet the privacy of that user may be preserved. In a first step 550, a vehicle tag is detected including the tag ID. This can be detected by security sensors at the parking facilities. In the case of RFID tags, this can be performed by RFID sensors located throughout the parking facilities. In a second step 555, the location of the vehicle carrying the tag is determined. That is, the vehicle may be approaching or at an entrance of the parking facilities, stopped at a parking location within the parking facilities, or at an exit of the parking facilities. If at an entrance, then processing continues to step 560. If stopped at a parking location, then processing continues to step 570. If at an exit, then processing continues to step 580.

In step 560, it is determined whether the tag ID is within the parking administrative database. If not, then entry to the parking facilities is denied to the vehicle in step 562 and processing ceases. If yes, then in step 564 it is determined from the parking attributes and accounting information stored in the parking administrative database whether the tag associated with that tag ID is authorized to park in the facility where the vehicle is entering. If not, then entry to the parking facilities is denied to the vehicle in step 562 and processing ceases. If yes, then in step 566 a record is created in the parking log database. This record will include the tag ID, the time of entry, and any applicable accounting information. Then in step 568 the vehicle is allowed entry to the parking facilities. Processing then ceases until the tag is again detected.

In step 570, it is determined from the parking attributes stored in the parking administrative database whether the vehicle is authorized to park at the location it has parked. That is, RFID or other sensors may be located at special needs or other restricted parking spaces. In addition, each tag may be for a specific reserved spot within the parking facility (which may match the human readable tag # on the tag). If authorized, then no action is taken and processing ceases. If not authorized, then in step 572 the log record parking attributes for that tag that does not have an exit time is updated with information about the unauthorized parking. This information may be later utilized to enact a parking fine or other punitive actions which may be stored in accounting information for the parking event. Then in step 574, a notification is sent of the parking violation. This notification may be sent to a security person of the parking administrator for action such as ticketing, putting a boot on the vehicle, or even towing depending on the severity of the unauthorized parking. This notification may also be sent to the tenant software for storage in the tenant database, for action to be taken by the tenant with the user of the tag such as a notification text sent to the user's mobile phone or an email to a manager of the user. Processing then ceases.

In step 580, the vehicle is exiting the parking facilities, so the log record for that tag that does not have an exit time is updated with the exit time. This allows for invoicing the tenant for the parking. It also allows one to determine how many vehicles are located within the parking facilities at any given time. Processing then ceases until the next tag is detected.

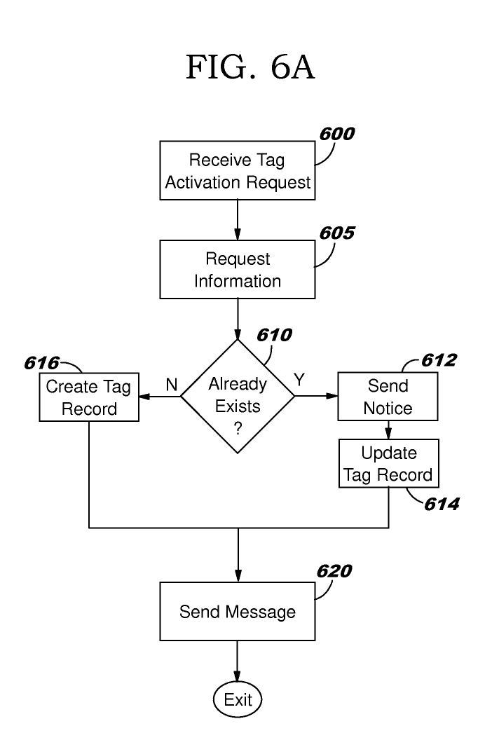

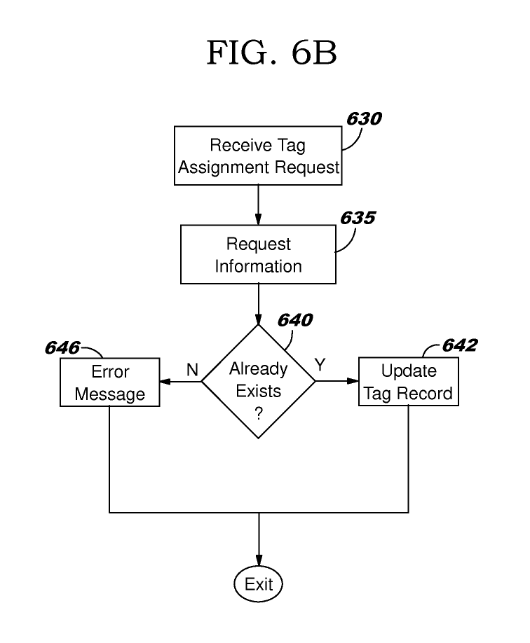

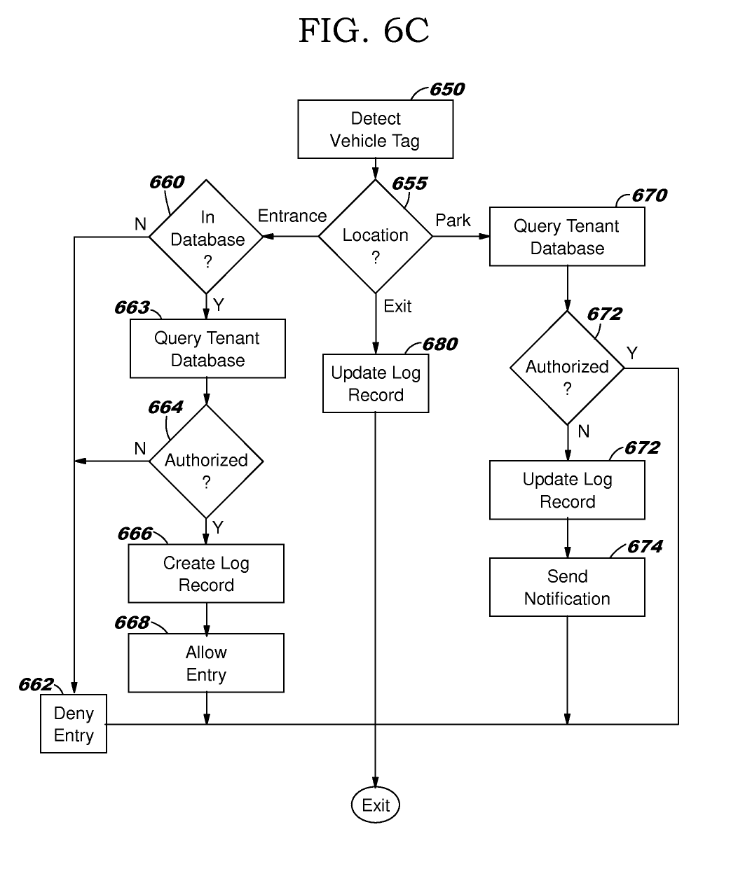

FIGS. 6A through 6C are flow diagrams of managing parking in accordance with the second embodiment. This first embodiment utilizes more downstream data flow from the tenant database to the parking administrative database upon request. This helps reduce synchronization maintenance between the parking administrative and tenant databases. FIG. 6A is a flow diagram of the parking management software associating a tag with a tenant in the parking administrative database. FIG. 6B is a flow diagram of the tenant software registering a tag with a user in the tenant database. FIG. 6C is a flow diagram of the parking management software managing a parking facility.

FIG. 6A is a flow diagram of the parking management software associating a tag with a tenant in the parking administrative database in accordance with the second embodiment. In a first step 600 a request is received to activate a tag by associating that a tag with a specific tenant. This request should originate at the parking administrator through a user interface with the parking administrative software. In response, the tag #, tag ID and tenant ID for that tag are requested in step 605. No parking attributes are requested as that information is not stored in the parking administrative database in this second embodiment. In step 610, it is determined whether a record for that tag already exists in the parking administrative database. This may occur is a tag is being recycled for use with the same or a different tenant. If yes in step 610, then in step 612 the tenant database for the old record is sent a notice that the tag is being recycled. Then in step 614, the record for that tag in the parking administrative database is updated with the newly provided information and processing continues to step 620. If no in step 610, then in step 616 a new record is created in the parking administrative database with the newly provided tag information and processing continues to step 620.

In step 620, a message is sent to the tenant database corresponding to the tenant #. This message includes the tag # and the tag ID. This allows the tenant database to generate a tag record as described below. Processing then ceases with regards to this tag until the tag is utilized for parking at a parking facility.

FIG. 6B is a flow diagram of the tenant software registering a tag with a user in the tenant database in accordance with the second embodiment. In a first step 630, a request is received to assign a tag with a specific user. This request should originate at the tenant through a user interface with the tenant software, database or domain, which may be linked to other tenant databases and software. In response, the tag #, tag ID, employee # (or other employee or user attribute) and any expected parking attributes for that tag are requested in step 635. For example, that user may be allowed to park in certain restricted parking spaces such as special needs parking or an employee of the month parking space. In step 640, it is determined whether a record for that tag already exists in the tenant database. This may occur if the tag is a new tag that was recently activated in the parking administrative database or if the tag is being recycled for use with the same or a different user. If yes in step 640, then in step 642 the old record in the tenant database is updated with the newly provided information. No information is sent to the parking administrative database in this embodiment at this time. Processing then ceases. If no in step 640, then the tag has not been activated in the parking administrative database, so in step 646 an error message is provided and processing ceases. Alternatively, the tenant software may perform the steps of activating the tag in the parking administrative database.

FIG. 6C is a flow diagram of the parking management software managing a parking facility in accordance with the second embodiment. In this embodiment, due to the parking attributes being stored in the tenant database, the tenant software and database needs to be queried each time a vehicle tag is detected to determine the parking attributes for that tag. However, queries to the tenant database are not intended to obtain private attribute information of the user. In a first step 650, a vehicle tag is detected including the tag ID. This can be detected by security sensors at the parking facilities. In the case of RFID tags, this can be performed by RFID sensors located throughout the parking facilities. In a second step 655, the location of the vehicle carrying the tag is determined. That is, the vehicle may be approaching or at an entrance of the parking facilities, stopped at a parking location within the parking facilities, or at an exit of the parking facilities. If at an entrance, then processing continues to step 660. If stopped at a parking location, then processing continues to step 670. If at an exit, then processing continues to step 680.

In step 660, it is determined whether the tag ID is within the parking administrative database. If not, then entry to the parking facilities is denied to the vehicle in step 662 and processing ceases. If yes, then the tenant database is queried for parking attributes associated with that tag ID in step 663. Then in step 664 it is determined from the parking attributes obtained from the tenant database whether the tag associated with that tag ID is authorized to park in the facility where the vehicle is entering. If not, then entry to the parking facilities is denied to the vehicle in step 662 and processing ceases. If yes, then in step 666 a record is created in the parking log database. This record will include the tag ID and the time of entry. Then in step 668 the vehicle is allowed entry to the parking facilities. Processing then ceases until the tag is again detected.

In step 670, the tenant database is queried such as through the tenant software to obtain the parking attributes for that vehicle. If the vehicle just entered the parking facility, that information may still be retained in memory and this step may be avoided. Then in step 672, it is determined from the parking attributes obtained from the tenant database whether the vehicle is authorized to park at the location it has parked. That is, RFID or other sensors may be located at special needs or other restricted parking spaces. In addition, each tag may be for a specific reserved spot within the parking facility (which may match the human readable tag # on the tag). If authorized, then no action is taken and processing ceases. If not authorized, then in step 672 the log record parking attributes for that tag, which does not have an exit time, is updated with information about the unauthorized parking. This information may be later utilized to enact a parking fine or other punitive actions. Then in step 674, a notification is sent of the parking violation. This notification may be sent to a security person of the parking administrator for action such as ticketing, putting a boot on the vehicle, or even towing depending on the severity of the unauthorized parking. This notification may also be sent to the tenant software for storage in the tenant database, for action to be taken with the user of the tag such as a notification text sent to the user's mobile phone or an email to a manager of the user. Processing then ceases.

In step 680, the vehicle is exiting the parking facilities, so the log record for that tag that does not have an exit time is updated with the exit time. This allows for invoicing the tenant for the parking. It also allows one to determine how many vehicles are located within the parking facilities at any given time. Processing then ceases until the next tag is detected.

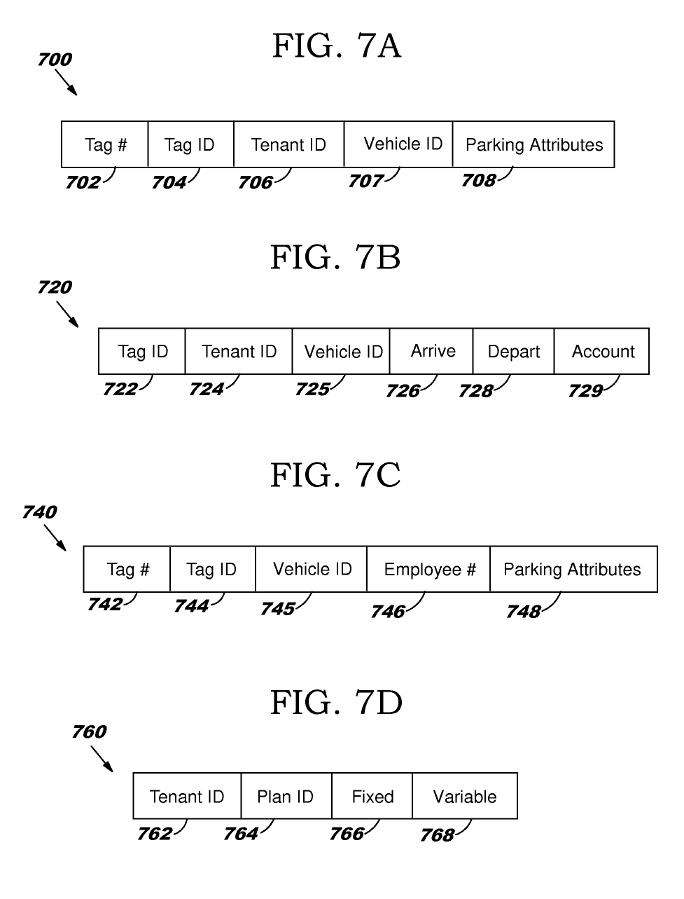

FIGS. 7A through 7D are block diagrams of types of database records in accordance with a third embodiment. FIG. 7A is a block diagram 700 of a record stored in a registration database for an assigned tag, which may be included in the parking administrative database. FIG. 7B is a block diagram 720 of a record stored in a usage database which can also be included in the parking administrative database. FIG. 7C is a block diagram 740 of a record stored in a tenant registration database for an assigned tag, which may be included in the tenant database. In each of these database records, identifying information regarding the vehicle parking with the tag is captured. This prevents the user from moving the tag among vehicles not preauthorized to park with the tag. While providing limitations of use, this embodiment provides greater parking security by preventing vehicle other than the one registered with the tag from using a tag. This still protects the privacy of the owner or lessee of the vehicle as no ownership or other user attribute data is stored. Vehicle license tags and other identifying information such as make and model are publicly visible information accessible by anyone in proximity to the vehicle. FIG. 7D is a block diagram 760 of a record stored in the parking administrative database and may also be mirrored in the tenant database for managing parking accounting.

FIG. 7A is a block diagram 700 of a record stored in a registration database for an assigned tag, which may be included in the parking administrative database. There may be one record for each tag provided to a tenant for use, although alternative embodiments may include one record per tenant with that record including a list of tags assigned to that tenant. Each record includes a tag number 702, a tag identifier 704, a tenant identifier 706, a vehicle identifier (e.g., license tag number) 707, and any parking attributes 708 for that tag. Tag number (tag #) 702 is a human readable unique number printed on the tag for ease of distinguishing between tags. Tag identifier (tag ID) 704 is a unique machine readable identifier such as a code emitted by an RFID chip which is used to identify a tag with a vehicle. Tenant identifier (tenant ID) 706 is an identifier of a tenant which may assign tags to its employees, guests or other persons. The tenant identifier is also linked to any leasing agreement between the parking administrative entity and the tenant. Vehicle identifier 707 is identifying information regarding a vehicle which is authorized to park at the parking facilities with this tag. This identifying information may be a license plate number, the make and model of the vehicle, etc. In addition, multiple entries may be allowed so a user may use the same tag for more than one preauthorized vehicle. Parking attributes 708 includes any parking privileges or restrictions associated with a given tag. As each tag is provided to a tenant to provide to its users, a record is created for that tag. Information such as parking attributes may be updated by the tenant as the tags are assigned to users or at other periods as desired. For example, if a user leaves the employment of the tenant, any tag associated with that user by the tenant may be voided and all parking privileges for that user may be revoked by the tenant. That is, the tenant may disassociate the user number or other user attributes from the tag ID as described below, which is uploaded to the parking administrative database as a “void” parking attribute. The parking management software will then disallow any vehicle with the void parking tag from parking in any parking lot until the tag is recovered from the user and returned to the parking administrator for reuse or reassignment to another tenant, or associated with another user by the tenant.

FIG. 7B is a block diagram 720 of a record stored in a usage database which can be included in the parking administrative database. One record may be automatically created each time a vehicle with a tag parks in the parking facilities (a parking event). This log may be utilized to invoice tenant for usage of the parking facilities. Each record includes the tag identifier 722, tenant identifier 724, vehicle identifier 725, arrival time 726, departure time 728, and relevant account information 729. Tag identifier 722 is detected by security devices and used to identify the tag being used at the time of parking. For ease of reference, the tenant identifier 724 associated with the tag may be included in this log record. The vehicle identifier 725 may be obtained through the use of optical recognition technology in combination with video cameras, through human recognition and data entry, or through other known approaches. The time of arrival 726, time of departure 728, and account information 729 are also included for determining the amount of time the vehicle was parked in the parking facility and the time of day of the parking. For example, the parking administrative entity may charge more or less for parking at certain times of day. Other information may be stored with each record such as where the vehicle was parked (i.e., which parking lot, parking space, etc.), whether the vehicle was improperly parked in an incorrect parking space, etc. This type of information may be useful in assigning parking fines or fees or for revoking parking privileges for a particular tag. Account information 729 maintains accounting information useful for managing charges and invoicing for this parking event. For example, charges may differ by where the user parks or which parking facility the user parks in, so that information may be captured here. In another example, if the tenant already had users parking as many vehicles in the parking facilities as allowed for the tenant, then extra charges may be levied for the additional vehicle, so that information may be captured here. The identity of the user is not included in this record or database, so the privacy of the user and his or her individual actions are maintained.

FIG. 7C is a block diagram 740 of a record stored in a tenant registration database for an assigned tag, which is included in the tenant database. Certain information in this record (e.g., the employee number or any other employee attribute information) is not shared with the parking administrative database for privacy purpose. In this example, there may be one record for each tag obtained for use from the parking administrative entity. Each record includes a tag number 742, a tag identifier 744, a vehicle identifier 745, an employee number 746 and any parking attributes 748 for that tag. Tag number (tag #) 742 is a human readable unique number printed on the tag for ease of distinguishing between tags. Tag identifier (tag ID) 744 is a unique machine readable identifier such as a code emitted by an RFID chip which is used to identify a tag with a vehicle. In an alternative embodiment, the tag ID may not be included as the tag number may be sufficient for interactions with the parking administrative database. Vehicle identifier 745 is identifying information regarding a vehicle which is authorized to park at the parking facilities with this tag. This identifying information may be a license plate number, the make and model of the vehicle, etc. In addition, multiple entries may be allowed so a user may use the same tag for more than one preauthorized vehicle. Employee number (employee #) 746 or other employee attribute is utilized to identify or describe a tenant employee or other authorized person and may be used to interface with any employee database of the tenant. Parking attributes 748 includes any parking privileges or restrictions associated with a given tag. Parking attributes may be updated by the tenant as the tags are assigned to users or at other periods as desired. For example, if a user leaves the employment of the tenant, any tag associated with that user may be voided by the tenant and all parking privileges revoked until the tag is associated with another employee. That is, the tenant may disassociate the employee number from the tag number, which is uploaded as a voided tag to the parking administrator (without necessitating uploading the employee number or other attribute information) and the tag may not be utilized for parking. However, once the tag is recovered by the tenant, the tag may be associated with another employee. The fact that the tag is no longer void and useful may then be uploaded as a parking attribute to the parking administrative database so that the tag may be utilized for parking again.

FIG. 7D is a block diagram 760 of an accounting record stored in the parking administrative database and may also be mirrored in the tenant database for managing parking accounting. This record may be accessible by the tenant identified for on-demand or periodic management by the tenant. There may be one record for each tenant, although alternative embodiments may utilize multiple records per tenant such as by parking facility for each tenant. This may be maintained in the parking administrative database with a mirror copy of individual records in tenant databases, although alternative embodiments may utilize alternative configurations.

A tenant ID 762 is an identifier of the tenant for identifying the tenant for which this record applies and for managing which tenant may access this record. Plan ID 764 is an identifier of an accounting plan selected by the tenant. For example, some plans may be static and only allow a certain number of parking spaces for certain parking lots at a given time. Other plans may be dynamic and allow extra parking spaces at a premium cost. Rather than having a detailed description of each plan in each record, an identifier is utilized instead which may be linked to an additional database with the plan details. Fixed 766 and variable 768 are standard limitations on the number of parking spaces allocated to a tenant at any given time. For example, a tenant may pay for 100 parking spaces at a low cost, but then will pay for an additional 20 spaces at any time at a premium cost should the need arise. Many other alternative configurations and types of data may be stored in this and other records.

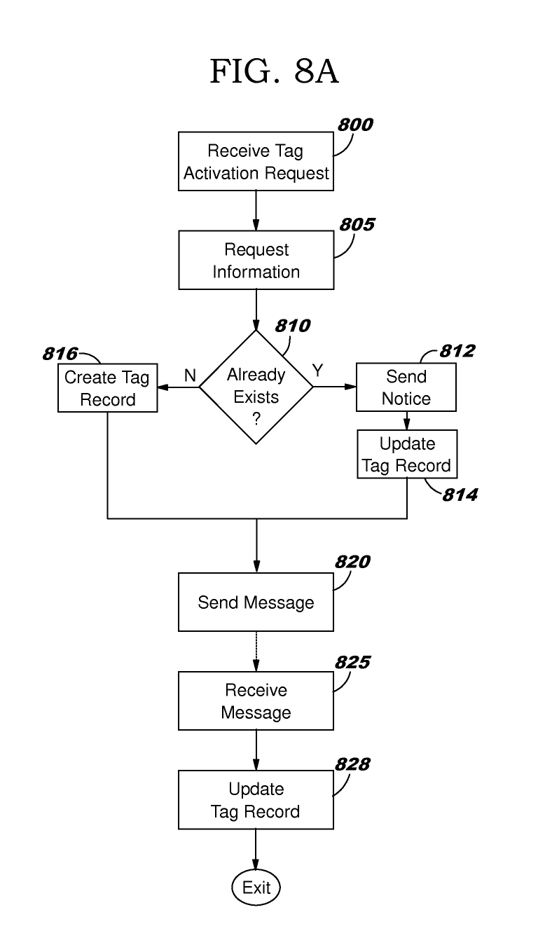

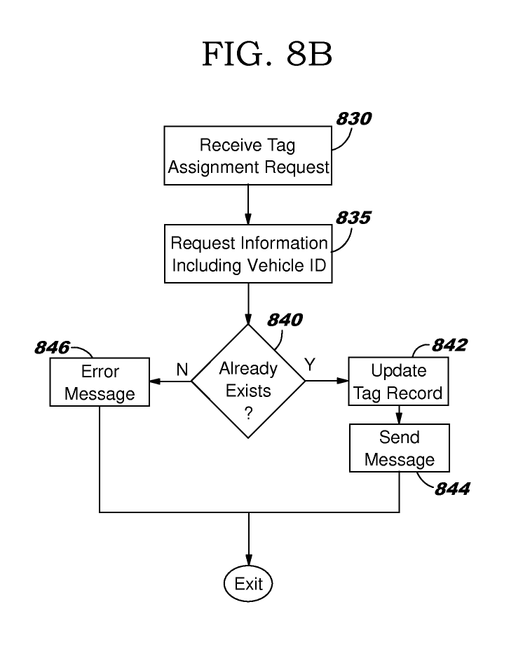

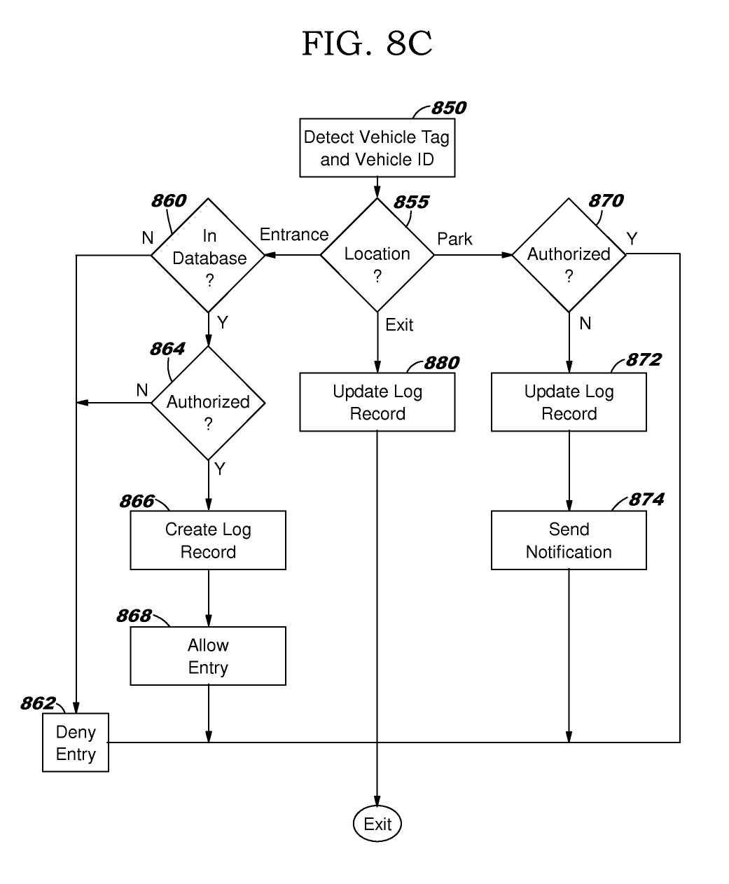

FIGS. 8A through 8C are flow diagrams of managing parking in accordance with the third embodiment. This third embodiment utilizes more upfront data flow from the tenant database to the parking administrative database similar to the first embodiment, but including identifying information regarding the vehicle authorized to park with a given tag. FIG. 8A is a flow diagram of the parking management software associating a tag with a tenant in the parking administrative database. FIG. 8B is a flow diagram of the tenant software registering a tag with a user in the tenant database. FIG. 8C is a flow diagram of the parking management software managing a parking facility.

FIG. 8A is a flow diagram of the parking management software associating a tag with a tenant in the parking administrative database in accordance with the first embodiment. In a first step 800 a request is received to activate a tag by associating that a tag with a specific tenant. This request should originate at the parking administrator through a user interface with the parking administrative software. In response, the tag #, tag ID, tenant ID and any expected parking attributes for that tag are requested in step 805. For example, a specific tenant may be restricted to a specific parking lot. In addition, the tag may also include a parking attribute code for disallowing parking with the tag until an update is received from the tenant software indicating the tag was assigned to a user. In step 810, it is determined whether a record for that tag already exists in the parking administrative database. This may occur is a tag is being recycled for use with the same or a different tenant. If yes in step 810, then in step 812 the tenant database for the old record is sent a notice that the tag is being recycled. Then in step 814, the record for that tag in the parking administrative database is updated with the newly provided information and processing continues to step 820. If no in step 810, then in step 816 a new record is created in the parking administrative database with the newly provided tag information and processing continues to step 820.

In step 820, a message is sent to the tenant database corresponding to the tenant #. This message includes the tag # and the tag ID. This allows the tenant database to generate a tag record as described below. Processing then ceases with regards to this tag until a message is received in step 825 indicating that the tag has been activated (assigned to an employee or other authorized person). This message should include any parking attributes such as whether the user can park in certain restricted spaces. Then in step 828, the tag record in the parking administrative database is updated and the parking attributes updated to allow use of the parking tag by a user. Processing then ceases unless a subsequent message is received from the tenant software with updated parking attributes. Such updated attributes could include cancelling the parking tag and thereby revoking the parking privileges associated with that tag.

FIG. 8B is a flow diagram of the tenant software registering a tag with a user in the tenant database in accordance with the first embodiment. In a first step 830, a request is received to assign a tag with a specific user. This request should originate at the tenant through a user interface with the tenant software, database or domain, which may be linked to other tenant databases and software. In response, the tag #, tag ID, vehicle ID (such as a license plate number), employee # and any expected parking attributes for that tag are requested in step 835. For example, that user may be allowed to park a certain vehicle in certain restricted parking spaces such as special needs parking or an employee of the month parking space. More than one vehicle ID may be provided if the user is allowed to utilize the tag on multiple vehicles. In step 840, it is determined whether a record for that tag already exists in the tenant database. This may occur if the tag is a new tag that was recently activated in the parking administrative database or if the tag is being recycled for use with the same or a different user. If yes in step 840, then in step 842 the old record in the tenant database is updated with the newly provided information and processing continues to step 844 where a message is sent to the parking administrative database with the vehicle ID and updated parking attributes for processing. Processing then ceases for this tag. If no in step 840, then the tag has not been activated in the parking administrative database, so in step 846 an error message is provided and processing ceases. Alternatively, the tenant software may perform the steps of activating the tag in the parking administrative database.

FIG. 8C is a flow diagram of the parking management software managing a parking facility in accordance with the first embodiment. In this embodiment, due to the parking attributes being stored in the parking administrative database, the tenant software and database does not need to be queried each time a person parks a vehicle with that tag. Queries to the tenant database should be very limited and are not intended to obtain private attribute information of the user. For example, if a car is parked in a restricted area such as a fire lane, then the tenant may be notified prior to the vehicle being towed (for notifying the user), yet the privacy of that user may be preserved. In a first step 850, a vehicle tag is detected including the tag ID. This can be detected by security sensors at the parking facilities. In the case of RFID tags, this can be performed by RFID sensors located throughout the parking facilities. The vehicle ID is also captured such as by optical recognition in combination with a video camera. In a second step 855, the location of the vehicle carrying the tag is determined. That is, the vehicle may be approaching or at an entrance of the parking facilities, stopped at a parking location within the parking facilities, or at an exit of the parking facilities. If at an entrance, then processing continues to step 860. If stopped at a parking location, then processing continues to step 870. If at an exit, then processing continues to step 880.

In step 860, it is determined whether the tag ID is within the parking administrative database. If not, then entry to the parking facilities is denied to the vehicle in step 862 and processing ceases. If yes, then in step 864 it is determined from the parking attributes and accounting information stored in the parking administrative database whether the tag associated with that tag ID and the vehicle ID is authorized to park in the facility where the vehicle is entering. If not, then entry to the parking facilities is denied to the vehicle in step 862 and processing ceases. If yes, then in step 866 a record is created in the parking log database. This record will include the tag ID, vehicle ID, the time of entry and any applicable accounting information. Then in step 868 the vehicle is allowed entry to the parking facilities. Processing then ceases until the tag is again detected.

In step 870, it is determined from the parking attributes stored in the parking administrative database whether the vehicle is authorized to park at the location it has parked. That is, RFID or other sensors may be located at special needs or other restricted parking spaces. In addition, each tag may be for a specific reserved spot within the parking facility (which may match the human readable tag # on the tag). In another example, the vehicle may be a large vehicle such as a truck and it may not be authorized to park in a parking space dedicated to small vehicles. If authorized, then no action is taken and processing ceases. If not authorized, then in step 872 the log record parking attributes for that tag that does not have an exit time is updated with information about the unauthorized parking. This information may be later utilized to enact a parking fine or other punitive actions and stored in accounting information for that parking event. Then in step 874, a notification is sent of the parking violation. This notification may be sent to a security person of the parking administrator for action such as ticketing, putting a boot on the vehicle, or even towing depending on the severity of the unauthorized parking. This notification may also be sent to the tenant software for storage in the tenant database, for action to be taken by the tenant with the user of the tag such as a notification text sent to the user's mobile phone or an email to a manager of the user. Processing then ceases.

In step 880, the vehicle is exiting the parking facilities, so the log record for that tag that does not have an exit time is updated with the exit time. This allows for invoicing the tenant for the parking. It also allows one to determine how many vehicles are located within the parking facilities at any given time. Processing then ceases until the next tag is detected.

A combination of the first, second and third embodiments may be utilized in combination. Some tenants or some parking areas may require vehicle IDs, some tenants may utilize different flows of information, etc. Other embodiments may also be utilized as appreciated by one of ordinary skill in the art.

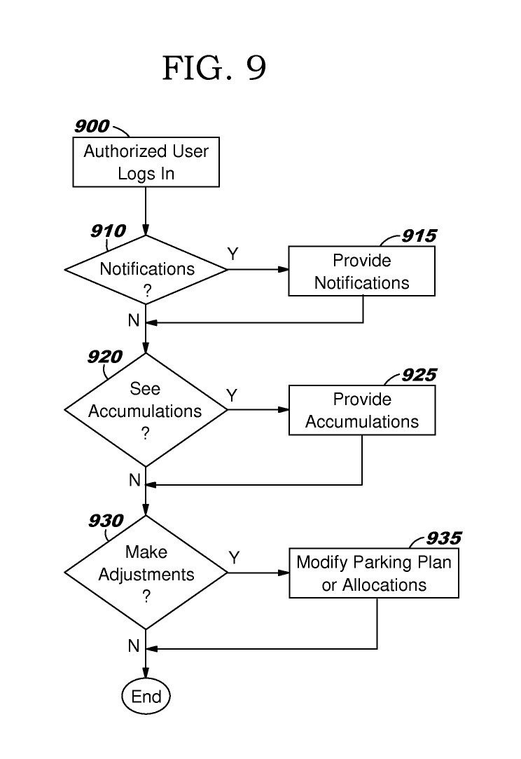

FIG. 9 is a flow diagram of managing an automated accounting system in which various embodiments may be implemented. In a first step 900, an authorized representative of a tenant can log onto the parking facility management system to access accounting information for that tenant. This includes accounting records such as shown in FIGS. 4D and 7D above, as well as parking event records (or accumulations of those records) such as shown in FIGS. 4B and 7B above. A tenant can only access records for that tenant (based on the tenant ID) and cannot access the records of other tenants in order to preserve privacy. As described above, these records may be located solely in the parking administrative database or mirrored in the tenant database. This information can be uploaded and downloaded between databases (domains) as needed. In a second step 910, it is determined whether there are any notifications to the tenant such as a vehicle being parked in the wrong location, a vehicle being parked in the parking facility for an extended period of time, etc. In an alternative embodiment, such notifications may be provided as they occur to the authorized person through email or other communication tool. If yes in step 910, then the notifications are provided to the tenant in step 915.

Processing then continues to step 920 where the authorized person is queried whether he or she wants to see any accumulations of parking for the past accounting period (e.g., since the first of the current month). If yes, then in step 925, the parking accumulations are provided to the authorized person. Details of those accumulations may be provided depending on the specific implementation of the system. Processing then continues to step 930 where the authorized person is queried whether he or she wants to make any adjustments to the current parking plan and allocation. For example, the tenant may desire to increase the number of fixed parking spaces due to a recent increase in tenant headcount. The tenant may also want to add or remove specific parking lots that its users may utilize for parking. These types of changes can be accomplished by choosing a different parking plan or by increasing or decreasing fixed and variable parking space allocations. If yes in step 930, then in step 935 the user is allowed to make the desired changes. Processing then ceases unless other capabilities are added to the specific implementation.

Given the flexibility of maintaining detailed records on parking by tag and by vehicle ID, many alternative billing arrangements may be utilized. For example, a tenant may be allowed a certain number of parking spaces at any given time for a fixed price per month. However, if that number is exceeded, then the tenant may be billed an additional charge for the excessive parking. Information can be provided to each tenant on an as needed or a periodic basis regarding the parking by vehicle with tags authorized by that tenant. This type of audit trail can be utilized to support billing to the tenant, but may also be useful by the tenant to identify parking trends by employees. Guests may be allowed to utilize temporary tags which may be assigned by a tenant or by the use of kiosks. However, such temporary tags may have greater parking restrictions due to security issues. For example, users with temporary tags may be required to park in designated visitor areas.

The invention can take the form of an entirely software embodiment, or an embodiment containing both hardware and software elements. In a preferred embodiment, the embodiments are implemented in software or program code, which includes but is not limited to firmware, resident software, and microcode.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM), or Flash memory, an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Further, a computer storage medium may contain or store a computer-readable program code such that when the computer-readable program code is executed on a computer, the execution of this computer-readable program code causes the computer to transmit another computer-readable program code over a communications link. This communications link may use a medium that is, for example without limitation, physical or wireless.

A data processing system suitable for storing and/or executing program code will include at least one processor coupled directly or indirectly to memory elements through a system bus. The memory elements can include local memory employed during actual execution of the program code, bulk storage media, and cache memories, which provide temporary storage of at least some program code in order to reduce the number of times code must be retrieved from bulk storage media during execution.

A data processing system may act as a server data processing system or a client data processing system. Server and client data processing systems may include data storage media that are computer usable, such as being computer readable. A data storage medium associated with a server data processing system may contain computer usable code such as for managing vehicle parking. A client data processing system may download that computer usable code, such as for storing on a data storage medium associated with the client data processing system, or for using in the client data processing system. The server data processing system may similarly upload computer usable code from the client data processing system such as a content source. The computer usable code resulting from a computer usable program product embodiment of the illustrative embodiments may be uploaded or downloaded using server and client data processing systems in this manner.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to explain the principles of the invention, the practical application, and to enable others of ordinary skill in the art to understand the invention for various embodiments with various modifications as are suited to the particular use contemplated.

The terminology used herein is for the purpose of describing particular embodiments and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method of administering a set of vehicle parking facilities shared by a plurality of tenants, each tenant having a plurality of users, each user having a vehicle, comprising:
managing an administrative domain accessible by a parking administrator containing a first set of records, each record of the first set including a unique tag identifier for identifying a tag, a set of parking attributes for that tag, and a tenant identifier for identifying one of the tenants, the administrative domain capable of communicating with a plurality of tenant domains, each tenant domain accessible by one of the tenants and associated with a subset of the unique tag identifiers, each unique tag identifier associated with a set of user attributes for identifying one of the users; and
managing an access enforcement system in communication with tag sensors and gates at access points of the vehicle parking facilities for reading tags to obtain a current tag identifier of a current vehicle at a current gate, querying the administrative domain with the tag identifier for determining whether to allow the current vehicle to proceed through the access point, and upon a positive determination providing a signal to the current gate allowing the current vehicle to proceed through the access point;
wherein the set of user attributes in the tenant domains are secured from access by the parking administrator.

2. The method of claim 1 wherein the access enforcement system is in communication with sensors for identifying a vehicle identifier of the current vehicle, and wherein the determination whether to allow the current vehicle to proceed through the access point includes determining whether the identified vehicle identifier is associated with the tag identifier.

3. The method of claim 1 further comprising managing parking access provided to users by each tenant managing parking attributes for tags associated with unique tag identifiers included in the tenant domain accessible by that tenant.

4. The method of claim 1 further comprising providing accounting information to each tenant according to the subset of unique tags associated with that tenant.

5. The method of claim 4 further comprising managing parking access provided to users by each tenant managing parking allocated to that tenant in the access enforcement system.

6. The method of claim 5 further comprising managing parking access costs by each tenant on-line and dynamically in the access enforcement system.

7. The method of claim 6 further comprising managing parking access provided to users by each tenant managing parking attributes for tags associated with unique tag identifiers included in the tenant domain accessible by that tenant; wherein the access enforcement system is in communication with sensors for identifying a vehicle identifier of the current vehicle; wherein the determination whether to allow the current vehicle to proceed through the access point includes determining whether the identified vehicle identifier is associated with the tag identifier.

8-20. (canceled)
